(19) United States
(12) Patent Application Publication
(10) Pub. No.: US 2011/0052401 A1
(43) Pub. Date: Mar. 3, 2011

(54) JOINED TURBINE ROTOR COMPONENTS AND METHOD THEREOF

(75) Inventors: Richard Brendon Scarlin, Oberflachs (CH); Martin Reigl, Ehrendingen (CH)

(73) Assignee: ALSTOM TECHNOLOGY LTD, Baden (CH)

(21) Appl. No.: 12/862,435

(22) Filed: Aug. 24, 2010

(30) Foreign Application Priority Data
Aug. 25, 2009 (EP) 09168600.6

(51) Int. Cl. F04D 29/38; B23K 31/02

(52) U.S. Cl. 416/223 R; 228/208; 228/170

(57) ABSTRACT

A method is disclosed for joining steel and nickel alloy turbine rotor components as is a joined turbine rotor combination produced by the method. The method includes: providing a steel rotor component; providing (e.g., laying down) a nickel alloy butter layer on the steel component; providing a nickel alloy rotor component; and welding the nickel alloy butter layer to the nickel alloy component using a nickel alloy weld filler so as to join together the components. The butter layer, laid first to the steel component, can enable reliable testing, for defects, of a nickel alloy/steel fusion line.

### RELATED APPLICATION

This application claims priority under 35 U.S.C. §119 to European Patent Application No. 09168600.5 filed in Europe on Aug. 25, 2009, the entire content of which is hereby incorporated by reference in its entirety.

### FIELD

The disclosure relates generally to gas or steam turbine rotors, including joining of turbine rotor components made, for example, of steel and nickel alloys.

### BACKGROUND INFORMATION

In the field of turbines it is known to use rotors that are made of different material sections. Such rotors can create challenges as different materials cannot always be easily joined.

Welding is one way of joining rotor component pieces together. US Pat. No. 4,962,586, for example, describes a joining solution that involves joining different steels. The solution involves laying down a butter layer on one of the components, heat treating the butter layer and then joining the other steel rotor component to the butter layer. U.S. Pat. No. 7,371,988 B2 describes another method of joining steel rotor components that also involves laying down a heat-treated butter layer on both of the components.

U.S. Pat. No. 7,168,916 B2 describes a method that involves joining steel and nickel alloy components using intermediate rotor rings. This solution provides one method of addressing resolution of defects at a transition from the nickel alloy to the steel due to an abrupt change in ultrasonic attenuation properties and the difficulty in detecting, from the outer surface of the welded joint, any defects lying in a fusion line.

As there is a continuing desire to join steel and nickel alloy turbine rotor components together, it would be desirable to provide alternate joining solutions.

### SUMMARY

A method for joining turbine rotor components is disclosed, comprising: a) providing a first rotor component made of steel; b) providing a nickel alloy butter layer on the first component; c) providing a second rotor component made of a nickel alloy; and d) welding the nickel alloy butter layer to the second component using a nickel alloy weld filler so as to join together the first rotor component to the second component.

A turbine rotor combination is disclosed, comprising: a first rotor component made of steel; a nickel alloy butter layer joined to the first rotor component; a nickel alloy weld filler joined to the nickel alloy butter layer; and a second rotor component made of nickel alloy joined to the nickel alloy weld filler, wherein the first rotor component, the nickel alloy butter layer, the weld filler and second rotor component lie in an axial series along a longitudinal axis.

### BRIEF DESCRIPTION OF THE DRAWINGS

Other aspects and advantages of the present disclosure will become apparent from the following description, taken in connection with the accompanying drawings wherein by way of illustration and example, an embodiment of the disclosure is disclosed, and wherein like reference numerals are used to refer to like elements throughout.

Exemplary embodiments of the disclosure are described more fully hereinafter with reference to the accompanying drawings, in which:

FIG. 1 is a flowchart of an exemplary method that involves laying down a nickel alloy butter layer;

FIG. 2 is a flowchart showing exemplary alternate steps that may be included in the method of FIG. 1; and

FIG. 3 is a sectional view of exemplary joined turbine rotor components.

### DETAILED DESCRIPTION

Joined turbine rotor components are disclosed, along with a method for manufacturing the same, wherein the turbine rotor components are made of steel and nickel alloys respectively. A joining method as disclosed herein can permit inspection of a steel/nickel alloy fusion line.

An exemplary method for joining turbine rotor components includes:
(a) providing a first rotor component made of steel;
(b) providing (e.g., laying down) a nickel alloy butter layer on the first rotor component;
(c) providing a second rotor component made of a nickel alloy; and
(d) welding the nickel alloy butter layer to the second component using a nickel alloy weld filler so as to join together the first rotor component to the second component.

In an exemplary method, a fusion line between steel and nickel of an alloy can easily be examined for detects (e.g., before the welding of step d)) while good access is available to the nickel alloy butter layer. According to exemplary methods, an intermediate heat treatment step, after laying of the nickel alloy butter layer but before joining of the first and second rotor components, is not required.

Another aspect of this disclosure is directed to joined turbine rotor components produced by the above method, wherein the first rotor component, the nickel alloy butter layer, the nickel alloy weld filler and second rotor component lie in axial series along a longitudinal axis.

In the following description, for purposes of explanation, numerous specific details are set forth in order to provide a thorough understanding regarding features of the disclosure. It may be evident, however, that the disclosure may be practiced without these specific details. In other instances, well-known structures and devices are shown in block diagram form in order to facilitate description of the disclosure.

Throughout this specification, a “butter layer” is defined as a layer of metal that has been laid down on a surface of a base component. As a result, a butter layer, during the laying down process, does not form a joint between components as it is applied only to a base component. A butter layer includes initial weld passes over which either additional weld passes or weld fillers, used to joint two surfaces together, can be applied.

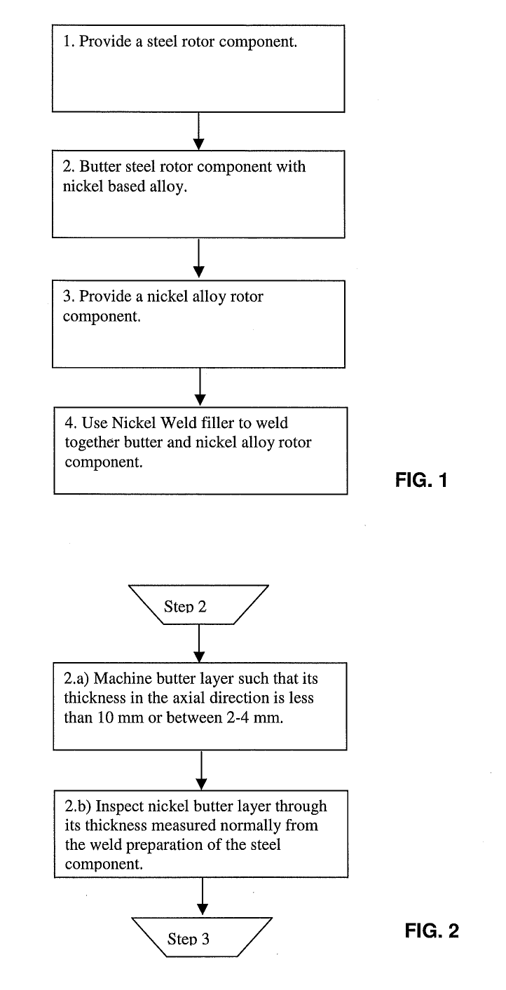

FIG. 1 shows steps of an exemplary method for joining of turbine rotor components 10, 30. The method includes first providing a steel rotor component 10 then laying down a nickel alloy butter layer 20 on the steel rotor component 10. A nickel alloy rotor component 30 is then provided and subsequently joined by welding to the nickel alloy butter layer 20 by means of a nickel alloy weld filler 25. By this process, the steel rotor component 10 is joined to the nickel alloy component 30.

Known methods for defect detection include eddy current and ultrasonic methods. These test methods can involve surface preparation of the butter layer in order to ensure that the testing surface has the desired smoothness. When the eddy current method is selected, the nickel alloy butter layer 25 thickness, measured normal to a weld preparation 15 of the steel rotor component 10, is for example greater than 2 mm and preferably between, for example, 2-4 mm. When the ultrasonic method is selected, the nickel alloy butter layer 25 thickness, measured normal to the weld preparation 15 of the steel rotor component 10, is for example greater than 3 mm, and preferably has an upper limit of, for example, 10 mm.

These exemplary thicknesses can provide an optimum defect resolution for these two test methods. In detecting defects in a region of a steel/nickel fusion line, as shown in FIG. 2, in an exemplary method, the thickness of the nickel alloy butter layer 25 can be controlled by a machining step completed after laying down of the nickel alloy butter layer 25.

A post weld heat treatment can be applied to the joined rotor components 10, 30 to, for example, relieve stress in the region of the heat-affected zones of the joint,

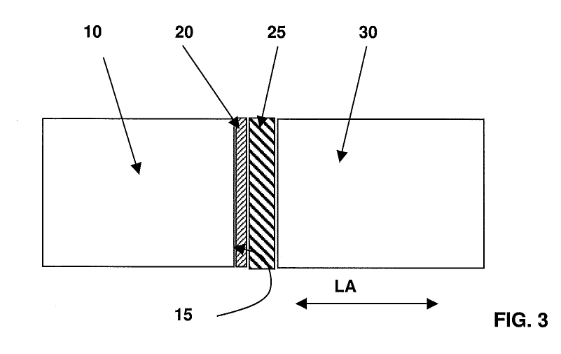

FIG. 3 shows exemplary joined turbine rotor components 10, 30, joined by methods shown in FIGS. 1 and 2. The joined turbine rotor components 10, 30 comprise, in joined axial series relative to a longitudinal axis LA, a steel rotor component 10, a nickel alloy butter layer 20, a nickel alloy weld filler 25 and a nickel alloy rotor component 30.

The nickel alloy butter layer 20 has a thickness, measured normal to the weld preparation 15 of the first component 10 of, in one exemplary embodiment, between about 2 to about 4 mm (or lesser or greater) and, in other exemplary embodiment, between about 3 to about 10 mm.

Although the disclosure has been herein shown and described in what is considered to be preferred exemplary embodiments, it will be appreciated by those skilled in the art that the present invention can be embodied in other specific forms without departing from the spirit of essential characteristics thereof. The presently disclosed embodiments are therefore considered in all respects to be illustrative and not restricted. The scope of the invention is indicated by the appended claims rather than the foregoing description and all changes that come within the meaning and range and equivalences thereof are intended to be embraced therein.

### REFERENCE NUMBERS

10 Steel rotor component

15 Weld preparation

20 Nickel alloy butter layer

25 Nickel alloy weld filler

30 Nickel alloy rotor component

LA Longitudinal axis

What is claimed is:

1. A method for joining turbine rotor components, comprising:
a) providing a first rotor component made of steel;
b) providing a nickel alloy butter layer on the first component;
c) providing a second rotor component made of a nickel alloy; and
d) welding the nickel alloy butter layer to the second component using a nickel alloy weld filler so as to join together the first rotor component to the second component.

2. The method of claim 1, comprising:
applying the nickel alloy butter layer such that a thickness of the nickel alloy butter layer, measured normal to a weld preparation of the first component, is between 2 to 4 mm.

3. The method of claim 1, comprising:
applying the nickel alloy butter layer such that a thickness of the nickel alloy butter layer, measured normal to a weld preparation of the first component, is between 3 to 10 mm.

4. The method of claim 2, comprising:
machining the nickel alloy butter layer after providing the nickel alloy butter layer on the first component to achieve a desired nickel alloy butter layer thickness.

5. The method of claim 1, comprising:
performing a post weld heat treatment after the welding.

6. The method of claim 1, wherein the first rotor component, the nickel alloy butter layer, the nickel alloy weld filler and second rotor component lie in axial series along a longitudinal axis.

7. A turbine rotor combination, comprising:
a first rotor component made of steel;
a nickel alloy butter layer joined to the first rotor component;
a nickel alloy weld filler joined to the nickel alloy butter layer; and
a second rotor component made of nickel alloy joined to the nickel alloy weld filler, wherein the first rotor component, the nickel alloy butter layer, the weld filler and second rotor component lie in an axial series along a longitudinal axis.

8. The turbine rotor combination of claim 7, wherein the nickel alloy butter layer has a thickness, measured normal to a weld preparation of the first component, of between 2 to 4 mm.

9. The turbine rotor combination of claim 7, wherein the nickel alloy butter layer has a thickness, measured normal to a weld preparation of the first component, of between 3 to 10 mm.

10. The method of claim 3, comprising:
machining the nickel alloy butter layer after providing the nickel alloy butter layer on the first component to achieve a desired nickel alloy butter layer thickness.

11. The method of claim 3, comprising:
performing a post weld heat treatment after the welding.

12. The method of claim 4, comprising:
performing a post weld heat treatment after the welding.
